(19) United States
(12) Patent Application Publication
(10) Pub. No.: US 2026/0114509 A1
(43) Pub. Date: Apr. 30, 2026

(54) AEROSOL GENERATING DEVICE AND OPERATION METHOD THEREOF

(71) Applicant: KT&G CORPORATION, Daejeon (KR)

(72) Inventors: In Su PARK, Daejeon (KR); Chan Min KWON, Daejeon (KR); Tae Kyun KIM, Daejeon (KR); Mi Jeong LEE, Daejeon (KR); John Tae LEE, Daejeon (KR); Tae Kyung LEE, Daejeon (KR)

(73) Assignee: KT&G CORPORATION, Daejeon (KR)

(21) Appl. No.: 18/927,247

(22) Filed: Oct. 25, 2024

(30) Foreign Application Priority Data
Aug. 30, 2023 (KR) 10-2023-0114878

(51) Int. Cl. A24F 40/46; A24D 1/00; A24D 1/20; A24F 40/20; A24F 40/51; A24F 40/53; A24F 40/57; A24F 40/60; H05B 6/80

(52) U.S. Cl. CPC A24F 40/46; A24D 1/002; A24D 1/20; A24F 40/20; A24F 40/51; A24F 40/53; A24F 40/57; A24F 40/60; H05B 6/804

(57) ABSTRACT

An aerosol generating device includes a oscillator configured to generate a microwave, a resonator including an accommodation space accommodating an aerosol generating article, the resonator configured to heat the aerosol generating article by resonating the microwave, a power monitoring unit configured to measure a reflected microwave reflected from the resonator and input to the oscillator, and a processor configured to determine a type of the aerosol generating article based on the reflected microwave measured by the power monitoring unit.

### CROSS-REFERENCE TO RELATED APPLICATION

This application is based on and claims priority under 35 U.S.C. § 119 to Korean Patent Application No. 10-2023-0114878, filed on Aug. 30, 2023, in the Korean Intellectual Property Office, the disclosure of which is incorporated by reference herein in its entirety.

### BACKGROUND

### 1. Field

The disclosure relates to an aerosol generating device, by which aerosols may be formed by heating an aerosol generating article through a dielectric heating method, and an operation method of the aerosol generating device.

### 2. Description of the Related Art

Recently, there is an increasing demand for alternative methods to overcome shortcomings of general cigarettes. For example, there is an increasing demand for a method of generating aerosols by heating a cigarette (or an ‘aerosol generating article’) by using an aerosol generating device, rather than by burning cigarettes.

Usually, aerosol generating devices are configured to generate aerosols by heating aerosol generating materials in a resistance heating method or an induction heating method. However, recently, aerosol generating devices of a dielectric heating type, in which aerosol generating materials are heated by using microwaves, have been proposed.

Aerosol generating devices of the dielectric heating type indicate devices configured to generate heat in dielectric materials included in aerosol generating materials according to resonance of microwaves and heat the aerosol generating materials by heat generated in the dielectric materials.

Power profiles for maintaining optimal vaporization performances may vary according to types of aerosol generating articles inserted into aerosol generating devices. When an aerosol generating device of a dielectric heating type includes an additional sensor configured to identify types of aerosol generating articles, manufacturing costs may be increased and it may be difficult to reduce a size of the aerosol generating device

### SUMMARY

According to an embodiment, provided is an aerosol generating device of a dielectric heating type, by which aerosol generating articles may be autonomously identified without addition of other insertion sensors.

Additional aspects will be set forth in part in the description which follows and, in part, will be apparent from the description, or may be learned by practice of the presented embodiments of the disclosure.

An aerosol generating device according to an embodiment includes a oscillator configured to generate a microwave, a resonator including an accommodation space accommodating an aerosol generating article, the resonator configured to heat the aerosol generating article by resonating the microwave, a power monitoring unit configured to measure a reflected microwave reflected from the resonator and input into the oscillator, and a processor configured to determine a type of the aerosol generating article based on the reflected microwave measured by the power monitoring unit.

An operation method of an aerosol generating device including an oscillator configured to generate a microwave, and a resonator including an accommodation space accommodating an aerosol generating article, the resonator configured to heat the aerosol generating article by resonating the microwave, includes identifying whether the aerosol generating article has been inserted into the accommodation space, generating an incident microwave output from the oscillator and input to the resonator when insertion of the aerosol generating article is sensed, measuring a reflected microwave reflected from the resonator and input to the oscillator, and determining a type of the aerosol generating article based on the measured reflected microwave.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of an aerosol generating device according an embodiment;

FIG. 2 is an internal block diagram of an aerosol generating device according to an embodiment;

FIG. 3 is an internal block diagram of a dielectric heater illustrated in FIG. 2;

FIG. 4 is a perspective view of a heater assembly according to an embodiment;

FIG. 5 is a cross-sectional view of the heater assembly illustrated in FIG. 4;

FIG. 6 is a perspective view schematically illustrating a heater assembly according to another embodiment;

FIG. 7 is a block diagram of an aerosol generating device according to an embodiment;

FIGS. 8A and 8B are diagrams for describing look-up tables including power profiles respectively corresponding to a plurality of aerosol-generating articles; and

FIG. 9 is a flowchart for describing an operation method of an aerosol generating device using a dielectric heating method.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments disclosed in this specification will be described in detail with reference to the accompanying drawings, and identical or similar components will be assigned the same reference numbers, regardless of the drawing symbols, and redundant explanations will be omitted.

The suffixes “module” and “unit” used in this description are assigned or used interchangeably solely for the convenience of drafting the specification and do not themselves have distinct meanings or roles.

Also, in describing the embodiments disclosed in this specification, detailed descriptions of well-known technologies may be omitted if it is determined that they could obscure the essence of the embodiments disclosed herein. Additionally, the accompanying drawings are provided merely to facilitate the understanding of the embodiments disclosed in this specification, and the technical spirit disclosed herein is not limited by the drawings. It should be understood that all modifications, equivalents, and substitutes that fall within the spirit and scope of this disclosure are included.

Terms including ordinal numbers, such as first, second, etc., may be used to describe various components, but the components are not limited by the terms. The above terms are used solely to distinguish one component from another.

When a component is referred to as being “connected” or “coupled” to another component, it should be understood that the component may be directly connected or coupled to the other component, or there may be intervening components in between. On the other hand, when a component is referred to as being “directly connected” or “directly coupled” to another component, it should be understood that there are no intervening components in between.

Singular expressions include plural expressions unless the context clearly indicates otherwise.

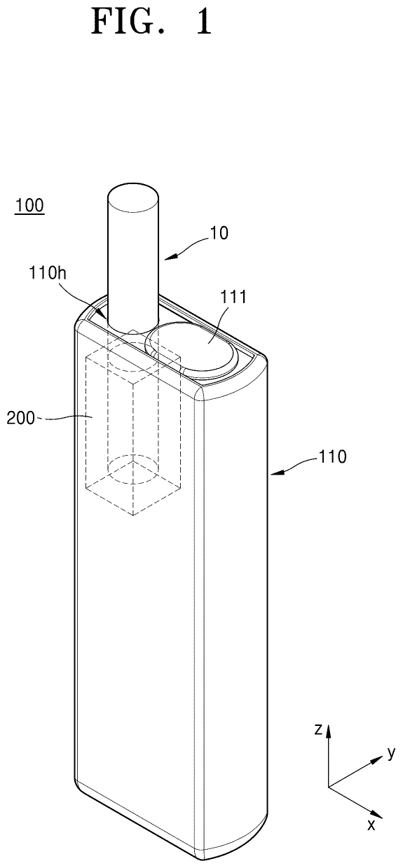

FIG. 1 is a perspective view of an aerosol generating device 100 according an embodiment.

Referring to FIG. 1, the aerosol generating device 100 according to an embodiment may include a housing 110 accommodating an aerosol generating article 10 and a heater assembly 200 configured to heat the aerosol generating article 10 accommodated in the housing 110.

The housing 110 may form an entire outward appearance of the aerosol generating device 100, and components of the aerosol generating device 100 may be arranged in an internal space (or a ‘mounting space’) of the housing 110. For example, the heater assembly 200, a battery, a processor, and/or a sensor may be arranged in the internal space of the housing 110, but the components arranged in the internal space are not limited thereto.

An insertion hole 110h may be formed in an area of the housing 110, and at least an area of the aerosol generating article 10 may be inserted into the housing 110 through the insertion hole 110h. For example, the insertion hole 110h may be formed in an area of a top surface (e.g., a surface facing a z direction) of the housing 100, but a position at which the insertion hole 110h is formed is not limited thereto. In other embodiments, the insertion hole 110h may also be formed in an area of a side surface (e.g., a surface facing an x direction) of the housing 110.

The heater assembly 200 may be arranged in the internal space of the housing 110 and may be configured to heat the aerosol generating article 10 inserted into or accommodated in the housing 110 through the insertion hole 110h. For example, the heater assembly 200 may be arranged to surround at least an area of the aerosol generating article 10 inserted into or accommodated in the housing 110 and configured to heat the aerosol generating article 10.

According to an embodiment, the heater assembly 200 may be configured to heat the aerosol generating article 10 in a dielectric heating method. In the disclosure, the ‘dielectric heating method’ indicates a method of heating a dielectric material, i.e., a heating object, by using resonance of a microwave and/or an electric field (or includes a magnetic field) of the microwave. The microwave, which is an energy source for heating the heating object, is generated by high-frequency power, and thus, hereinafter, the microwave and microwave power may be used interchangeably.

In the heater assembly 200, electric charges to ions of a dielectric material included in the aerosol generating article 10 may vibrate or rotate due to resonance of the microwave, and due to friction heat generated during vibration or rotation of the electric charges to ions, heat may be generated in the dielectric material and the aerosol generating article 10 may be heated.

As the aerosol generating article 10 is heated by the heater assembly 200, aerosols may be generated from the aerosol generating article 10. In the disclosure, the term ‘aerosols’ may indicate gas particles generated when vapor, which is generated as the aerosol generating article 10 is heated, is mixed with air.

The aerosols generated from the aerosol generating article 10 may pass through the aerosol generating article 10 or may be discharged to outside of the aerosol generating device 100 through an empty space between the aerosol generating article 10 and the insertion hole 110h. A user may smoke by contacting an area of the aerosol generating article 10, which is exposed outside the housing 110, with his/her mouth and inhaling aerosols discharged to the outside of the aerosol generating device 100.

The aerosol generating device 100 according to an embodiment may further include a cover 111 arranged in a movable manner on the housing 110 and used for opening or closing the insertion hole 110h. For example, the cover 111 may be combined in a slidable manner to the top surface of the housing 110 and may expose the insertion hole 110h to the outside of the aerosol generating device 100 or cover the insertion hole 110h to prevent the insertion hole 110h from being exposed to the outside of the aerosol generating device 100.

In an example, the cover 111 may expose the insertion hole 110h to the outside of the aerosol generating device 100 at a first position (or ‘an opening position’). When the aerosol generating device 100 is exposed outside, the aerosol generating article 10 may be inserted into the housing 110 through the insertion hole 110h.

In another example, the cover 111 may prevent the insertion hole 110h from being exposed to the outside of the aerosol generating device 100 by covering the insertion hole 110h at a second position (or ‘a closing position’). In this case, when the aerosol generating device 100 is not in use, the cover 111 may prevent foreign materials from being introduced into the heater assembly 200 through the insertion hole 110h.

Although FIG. 1 only illustrates the aerosol generating device 100 configured to heat the aerosol generating article 10 that is in a solid state, the aerosol generating device 100 is not limited to the embodiment illustrated in FIG. 1.

An aerosol generating device according to another embodiment may also be configured to generate aerosols by heating, through the heater assembly 200, an aerosol generating material in a liquid state or a gel state, rather than the aerosol generating article 10 in the solid state.

An aerosol generating device according to another embodiment may include the heater assembly 200 configured to heat the aerosol generating article 10 and a cartridge (or a ‘vaporizer’) including an aerosol generating material in a liquid state or a gel state and configured to heat the aerosol generating material. The aerosols generated from the aerosol generating material may move to the aerosol generating article 10 through an air flow path connected to the cartridge and the aerosol generating article 10, may be mixed with the aerosols generated from the aerosol generating article 10, and may be delivered to the user through the aerosol generating article 10.

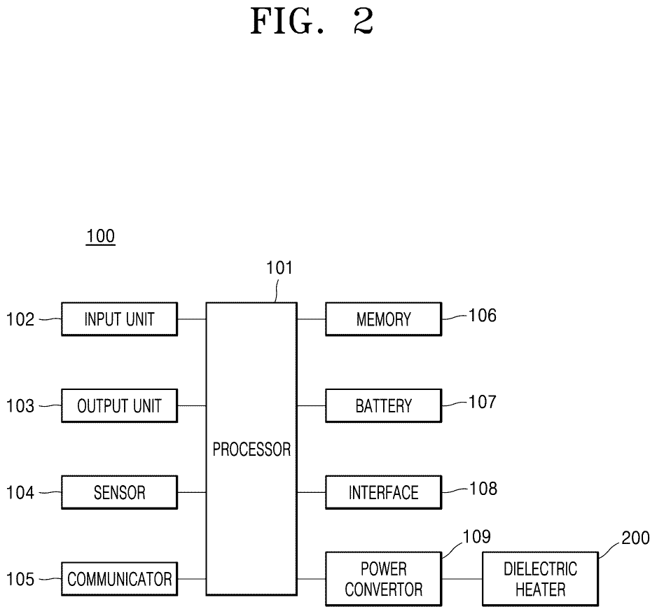

FIG. 2 is an internal block diagram of the aerosol generating device 100 according to an embodiment.

Referring to FIG. 2, the aerosol generating device 100 may include a processor 101 an input unit 102, an output unit 103, a sensor 104, a communicator 105, a memory 106, a battery 107, an interface unit 108, a power converter 109, and a dielectric heater 200.

The input unit 102 may be configured to receive user inputs. For example, the input unit 102 may be provided in a form of a single pressing push button. In another example, the input unit 102 may include a touch panel including at least one touch sensor. The input unit 102 may be configured to deliver an input signal to the processor 101. The processor 101 may be configured to provide power to the dielectric heater 200 or output notification for the user by controlling the output unit 103, based on the user inputs.

The output unit 103 may be configured to output information regarding a state of the aerosol generating device 100. The output unit 103 may be configured to output information regarding a charged/discharged state of the battery 107, a heating/heating-stopped state of the dielectric heater 200, an insertion state of the aerosol generating article 10, and error of the aerosol generating device 100. To do so, the output unit 103 may deliver information regarding the state of the aerosol generating device 100 to the user, by using any one of a visual sense, an auditory sense, and a tactile sense. For example, the output unit 103 may include a display, a haptic motor, and a sound output unit.

The sensor 104 may be configured to sense the state of the aerosol generating device 100 or a state of a periphery of the aerosol generating device 100 and deliver sensed information to the processor 101. The processor 101 may be configured to control the aerosol generating device 100, based on the sensed information, to perform various functions such as control on heating of the dielectric heater 200, smoking limitation, determination on whether the aerosol generating article 10 has been inserted, and notification display.

The sensor 104 may include a temperature sensor, a puff sensor, and an insertion sensor.

The temperature sensor may be configured to sense a temperature in the dielectric heater 200 in a non-contacting manner, or may directly obtain a temperature of an oscillator by being in contact with the dielectric heater 200. According to embodiments, the temperature sensor may also be configured to sense the temperature of the aerosol generating article 10. In addition, the temperature sensor may be arranged adjacent to the battery 107 and may acquire a temperature of the battery 107. The processor 101 may be configured to control power provided to the dielectric heater 200, based on temperature information of the temperature sensor.

The puff sensor may be configured to sense puffs of the user. The puff sensor may be configured to sense the puffs of the user, based on at least one of a temperature change, a flow change, a power change, and a pressure change. The processor 101 may be configured to control the power provided to the dielectric heater 200, based on puff information of the puff sensor. For example, the processor 101 may be configured to count the number of puffs, and when the number of puffs arrives at a preset maximum number of puffs, the processor 101 may block the power provided to the dielectric heater 200. As another example, when the puffs have not been detected for a preset time period or longer, the processor 101 may block the power provided to the dielectric heater 200.

The insertion sensor may be arranged in or near an accommodation space 220h, and may sense insertion and removal of the aerosol generating article 10 accommodated in the insertion hole 110h. For example, the insertion sensor may include at least one of a film sensor, a pressure sensor, an optical sensor, a resistive sensor, a capacity sensor, an inductive sensor, and an infrared ray sensor. When the aerosol generating article 10 is inserted into the insertion hole 110h, the processor 101 may provide the power to the dielectric heater 200.

According to embodiments, the sensor 104 may further include a reuse sensor, a motion sensor, a humidity sensor, an atmospheric pressure sensor, a magnetic sensor, a cover attachment/detachment sensor, a global positioning system (GPS) sensor, and a proximity sensor. As functions of the sensors may be intuitively derived from names of the sensors, detailed descriptions thereof will not be given.

The communicator 105 may include at least one communication module for communication with external electronic devices. The processor 101 may be configured to control the communicator 105 to transmit the information regarding the aerosol generating device 100 to the external electronic devices. Alternatively, the processor 101 may be configured to receive information from the external electronic devices through the communicator 105 and control the components included in the aerosol generating device 100. For example, the information transmitted between the communicator 105 and the external electronic devices may include user authentication information, firmware update information, user smoking pattern information, and the like.

As hardware configured to store various types of data processed in the aerosol generating device 100, the memory 106 may be configured to store data processed or to be processed in the processor 101. For example, the memory 106 may be configured to store data regarding an operation time, a maximum number of puffs, the number of current puffs, at least one temperature profile, and a user smoking pattern.

The battery 107 may be configured to provide the power to the dielectric heater 200 such that the aerosol generating article 10 is heated. In addition, the battery 107 may be configured to provide the power necessary for operations of other components provided in the aerosol generating device 100. The battery 107 may include a rechargeable battery, or may include a detachable battery that may be separated.

The interface unit 108 may include a connection terminal that may be physically connected to the external electronic devices. The connection terminal may include at least one of a High-Definition Multimedia Interface (HDMI) connector, a Universal Serial Bus (USB) connector, a Secure Digital (SD) card connector, or an audio connector (e.g., a headphone connector) or a combination thereof. The interface unit 108 may be configured to transmit/receive information to/from the external electronic device or recharge the power.

The power converter 109 may be configured to convert direct power, which is provided from the battery 107, into alternating power. In addition, the power converter 109 may also be configured to provide the converted alternating power to the dielectric heater 200. The power converter 109 may include an inverter including at least one switching device, and the processor 101 may be configured to convert the direct power to the alternating power by controlling on/off of the switching device included in the power converter 109. The power converter 109 may include a full-bridge converter or a half-bridge converter.

The dielectric heater 200 may be configured to heat the aerosol generating article 10 in a dielectric heating method. The dielectric heater 200 may include a component corresponding to the heater assembly 200 illustrated in FIG. 1.

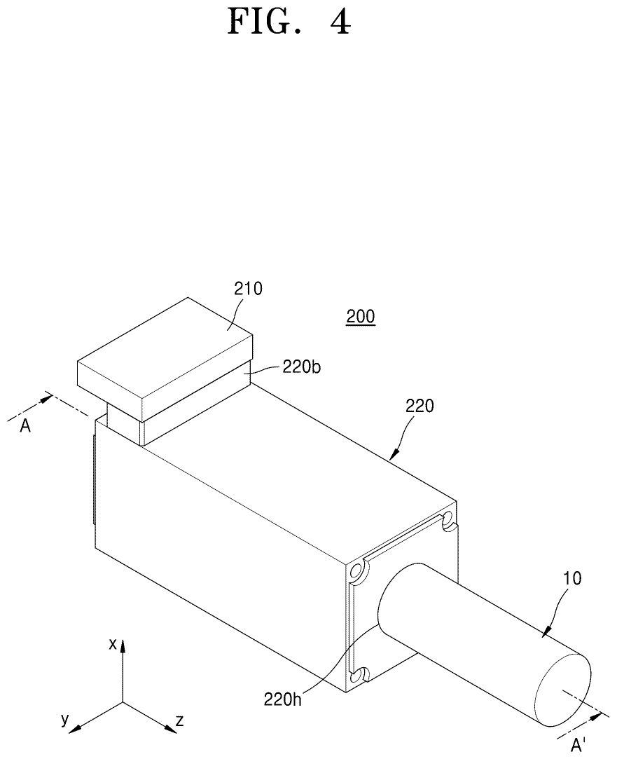

The dielectric heater 200 may be configured to heat the aerosol generating article 10 by using a microwave and/or an electric field of the microwave (when there is no need of distinction, will be referred to as the microwave or microwave power). A heating method performed by the dielectric heater 200 may include a method of heating the heating object by forming the microwave in a resonance structure, rather than a method of radiating the microwave by using an antenna. The resonance structure will be described later with reference to FIG. 4 and thereafter.

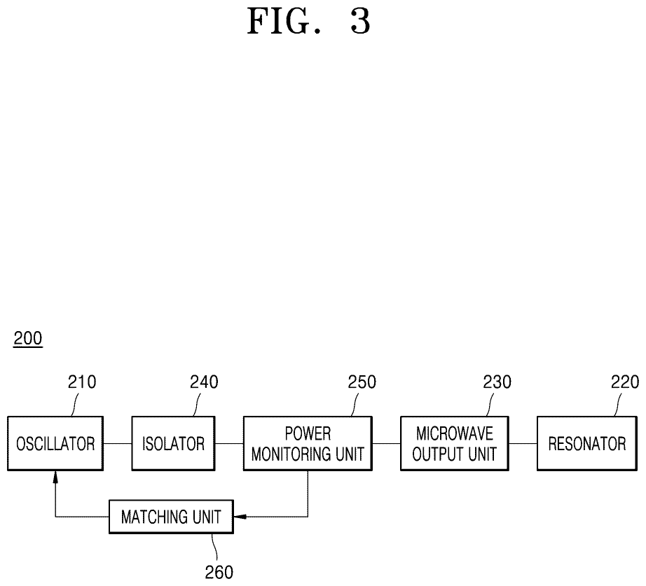

The dielectric heater 200 may be configured to output the microwave, which is a high-frequency wave, to a resonator 220 (see FIG. 3). The microwave may include power in Industrial Scientific and Medical equipment (ISM) band allowed for heating, but is not limited thereto. The resonator 220 may be designed in consideration of a wavelength of the microwave such that the microwave may be resonated in the resonator 220.

The aerosol generating article 10 may be inserted into the resonator 220, and a dielectric material in the aerosol generating article 10 may be heated by the resonator 220. For example, the aerosol generating article 10 may include a polar material, and particles in the polar material may be polarized in the resonator 220. The particles may vibrate or rotate due to polarization, and the aerosol generating article 10 may be heated by frictional heat and the like generated during the vibration or rotation of the particles. Descriptions of the dielectric heater 200 will be given in further detail with reference to FIG. 3.

The processor 101 may be configured to control general operations of the aerosol generating device 100. The processor 101 may be implemented as an array of a plurality of logic gates, and may also be implemented as a combination of a general-purpose microprocessor and a memory in which a program executed by the microprocessor is stored. The processor 101 may also be implemented as other types of hardware.

The processor 101 may be configured to control direct power provided from the battery 107 to the power converter 109 and/or alternating power provided from the power converter 109 to the dielectric heater 200, according to power required by the dielectric heater 200. In an embodiment, the aerosol generating device 100 may include a converter configured to boost or buck the direct power, and the processor 101 may be configured to control the converter to adjust intensity of the direct power. In addition, the processor 101 may be configured to control the alternating power provided to the dielectric heater 200 by adjusting a switching frequency and a duty ratio of the switching device included in the power converter 109.

The processor 101 may be configured to control a heating temperature of the aerosol generating article 10 by controlling the microwave power of the dielectric heater 200 and a resonance frequency of the dielectric heater 200. Accordingly, an oscillator 210, an isolator 240, a power monitoring unit 250, and a matching unit 260 illustrated in FIG. 3 to be described later may include some of components included in the processor 101.

The processor 101 may be configured to control the microwave power of the dielectric heater 200 based on temperature profile information stored in the memory 106. In other words, a temperature profile may include information regarding a target temperature of the dielectric heater 200 according to time, and the processor 101 may be configured to control the microwave power of the dielectric heater 200 according to time.

The processor 101 may be configured to adjust a frequency of the microwave such that the resonance frequency of the dielectric heater 200 is constant. The processor 101 may track real-time changes in the resonance frequency of the dielectric heater 200 as the heating object is heated, and may control the dielectric heater 200 such that the frequency of the microwave according to changed resonance frequency is output. In other words, the processor 101 may be configured to change the frequency of the microwave in real time, regardless of the temperature profile stored in advance.

FIG. 3 is an internal block diagram of the dielectric heater 200 illustrated in FIG. 2.

Referring to FIG. 3, the dielectric heater 200 may include the oscillator 210, the isolator 240, the power monitoring unit 250, the matching unit 260, a microwave output unit 230, and the resonator 220.

The oscillator 210 may be configured to receive the alternating power from the power converter 109 and generate microwave power having a high frequency. According to embodiments, the power converter 109 may be a component included in the oscillator 210. The microwave power may be selected from 915 MHz, 2.45 GHz, and 5.8 GHz frequency bands included in the ISM bands.

The oscillator 210 may include a solid-state-based radio frequency (RF) generator, and may generate the microwave power by using the solid-state-based RF generator. The solid-state-based RF generator may be implemented in a form of a semiconductor. When the oscillator 210 is implemented as a semiconductor, a size of the dielectric heater 200 may be reduced, and life of the device may be prolonged.

The oscillator 210 may be configured to output the microwave power to the resonator 220. The resonator 210 may include a power amplifier configured to increase or decrease the microwave power, and the power amplifier may be configured to adjust intensity of the microwave power under control of the processor 101. For example, the power amplifier may be configured to decrease or increase an amplitude of the microwave. As the amplitude of the microwave is adjusted, the microwave power may be adjusted.

The processor 101 may be configured to adjust the intensity of the microwave power output from the oscillator 210, based on a power profile (or the temperature profile) stored in advance. For example, the power profile may include target temperature information according to pre-heating periods and smoking periods, the oscillator 210 may be configured to provide the microwave power as first power in the pre-heating period and provide the microwave power as second power, which is less than the first power, in the smoking periods.

The processor 101 may be configured to adjust the intensity of the microwave power output from the oscillator 210, based on an operation mode of the aerosol generating device 100. For example, the aerosol generating device 100 may be configured to operate in a standby mode and a heating mode. The standby mode indicates a state that the aerosol generating device 100 is power-on but the heater assembly (or the dielectric heater) 200 does not perform a heating operation. The heating mode, in which the heater assembly 200 performs the heating operation, may be divided into the pre-heating period and the smoking period.

The oscillator 210 may be configured to provide the microwave power as the first power in the standby mode and provide the microwave power as second power, which is greater than the first power, in the heating mode.

In the standby mode, the processor 101 may be configured to determine a type of the aerosol generating article 10.

In the heating mode, the oscillator 210 may be configured to adjust the intensity of the microwave power output from the oscillator 210, based on the power profile corresponding to the type of the aerosol generating article 10 determined in the standby mode. For example, the heating profile may include the target temperature information according to the pre-heating periods and the smoking periods, the oscillator 210 may be configured to provide the microwave power as 2-1 power in the pre-heating period and provide the microwave power as 2-2 power, which is less than the 2-1 power, in the smoking period.

The isolator 240 may be configured to block the microwave power input from the resonator 220 to the oscillator 210. Although most of the microwave power output from the oscillator 210 is absorbed into the heating object, according to heating patterns of the heating object, a portion of the microwave power may be reflected by the heating object and transmitted again toward the oscillator 210. This is due to a change in an impedance from the oscillator 210 to the resonator 220 due to exhaustion of polar particles as the heating object is heated. ‘The impedance from the oscillator 210 to the resonator 220 changes’ may indicate a same meaning as ‘the resonance frequency of the resonator 220 changes.’ When the microwave power reflected from the resonator 220 is input to the oscillator 210, expected output performance may be not exhibited, as well as breakage of the oscillator 210. The isolator 240 may induce the microwave power reflected from the resonator 220 in a certain direction and absorb the microwave power, without returning the microwave power to the oscillator 210. To do so, the isolator 240 may include a circulator and a dummy load.

The power monitoring unit 250 may be configured to monitor each of incident microwave power reflected from the oscillator 210 and reflected microwave power reflected from the resonator 220. The power monitoring unit 250 may be configured to transmit, to the matching unit 260, information regarding the incident microwave power and the reflected microwave power.

Characteristics of reflection of the microwave in the resonator 220 may vary according to a permittivity in the resonator 220. The permittivity is an important characteristic value indicating electrical characteristics of a dielectric material, i.e., a nonconductor. The permittivity does not indicate electrical characteristics of a direct current (DC), but is directly related to characteristics of an alternating current (AC), and more particularly, to characteristics of an alternating electromagnetic wave. More particularly, the intensity of the reflected microwave reflected from the resonator 220 may vary according to a complex permittivity in the resonator 220. In the resonator 220, an absorbance of the microwave may be expressed as a loss tangent, i.e., a ratio of an imaginary part of the complex dielectric constant to a real part of the complex dielectric constant. In addition, a phase of the reflected microwave reflected from the resonator 220 may vary according to the permittivity in the resonator 220. The aerosol generating article 10 inserted into the accommodation space 220h of the resonator 220 includes different dielectric materials according to type of the aerosol generating article 10, and therefore, the resonator 220 may have different permittivities. Accordingly, the type of the aerosol generating article 10 inserted into the accommodation space of the resonator 220 may be determined by analyzing the reflected microwave reflected from the resonator 220.

The matching unit 260 may be configured to match the impedance from the oscillator 210 to the resonator 220 and the impedance from the resonator 220 to the oscillator 210, such that the reflected microwave power has a minimum value. Impedance matching may indicate a same meaning as matching a frequency of the oscillator 210 and the resonance frequency of the resonator 220. Accordingly, the matching unit 260 may change the frequency of the oscillator 210 to match the impedances. In other words, the matching unit 260 may be configured to adjust the frequency of the microwave power output from the oscillator 210 such that the reflected microwave power has the minimum value. The impedance matching by the matching unit 260 may be performed in real time, regardless of the temperature profile.

The oscillator 210, the isolator 240, the power monitoring unit 250, and the matching unit 260 described above may be separate components distinguished from the microwave output unit 230 and the resonator 220 to be described hereinafter, and may be implemented as a chip-type microwave source. In addition, according to embodiments, the oscillator 210, the isolator 240, the power monitoring unit 250, and the matching unit 260 may also be implemented as some components of the processor 101.

The microwave output unit 230, which is a component configured to input the microwave power into the resonator 220, may be a component corresponding to a coupler illustrated in FIG. 3 and thereafter. The microwave output unit 230 may be implemented in forms of Sub-Miniature A (SMA), Sub-Miniature B (SMB), Micro Coaxial (MCX), and Micro Miniature Coaxial (MMCX) connectors. The microwave output unit 230 may connect the chip-type microwave source and the resonator 220 to each other and deliver the microwave power, which is generated in the microwave source, to the resonator 220.

The resonator 220 may be configured to heat the heating object by generating the microwave in the resonance structure. The resonator 220 may include the accommodation space in which the aerosol generating article 10 is accommodated, and the aerosol generating article 10 may be exposed to the microwave and dielectrically heated. For example, the aerosol generating article 10 may include a polar material, and particles in the polar material may be polarized by the microwave in the resonator 220. The particles may vibrate or rotate due to polarization, and the aerosol generating article 10 may be heated by frictional heat and the like generated during the vibration or rotation of the particles.

The resonator 220 may include at least one inner conductor such that the microwave may be resonated, and the microwave may be resonated in the resonator 220 according to an arrangement, a thickness, a length and the like of the inner conductor.

The resonator 220 may be designed in consideration of the wavelength of the microwave such that the microwave may be resonated in the resonator 220. For the microwave to be resonated in the resonator 220, the resonator 220 needs a short end, in which a cross-section thereof is closed, and an open end opposite to the short end, wherein at least an area of a cross-section of the open end is open. In addition, it is required that a length between the short end and the open end is set as an integer multiple of ¼ of the wavelength of the microwave. To reduce the size of the aerosol generating device 100, a ¼ length of the wavelength of the microwave is selected for the resonator 220 of the disclosure. In other words, the length between the short end and the open end of the resonator 220 may be set as the length of ¼ of the wavelength of the microwave.

The resonator 220 may include a dielectric material-accommodation space. In the dielectric material-accommodation space, which is a component distinguished from the accommodation space of the aerosol generating article 10, a material capable of changing the resonance frequency of an entire portion of the resonator 220 and reducing a size of the resonator 220 is arranged. In an embodiment, a dielectric material having a low microwave absorbance may be accommodated in the dielectric material-accommodation space. This is to prevent heating of the dielectric material itself caused as energy to be delivered to the heating object is delivered to the dielectric material. The absorbance of the microwave may be expressed as the loss tangent, i.e., the ratio of the imaginary part of the complex dielectric constant to the real part of the complex dielectric constant. In an embodiment, a dielectric material having a loss tangent equal to a preset value or smaller may be accommodated in the dielectric material-accommodation space 227, and the preset value may be 1/100. For example, the dielectric may include at least one of quartz, tetrafluoroethylene, and aluminum oxide, or a combination thereof, but is not limited thereto.

FIG. 4 illustrates a perspective view of the heater assembly 200 according to an embodiment.

Referring to FIG. 4, the heater assembly 200 according to an embodiment may include the oscillator 210 and the resonator 220. FIG. 4 may illustrate an embodiment of the heater assembly 200 and the dielectric heater 200 described above, and hereinafter, same descriptions will not be repeatedly given.

As the power is provided, the oscillator 210 may generate the microwave in a determined frequency band. The microwave generated in the oscillator 210 may be delivered to the resonator 220 through a coupler (not shown).

The resonator 220 may include the accommodation space 220h accommodating at least an area of the aerosol generating article 10, and may heat the aerosol generating article 10 in the dielectric heating method by resonating the microwave generated in the oscillator 210. For example, due to the resonance of the microwave, electric charges of glycerin included in the aerosol generating article 10 may vibrate or rotate, and friction heat generated during vibration or rotation of the electric charge causes heat generation in glycerin, and thus, the aerosol generating article 10 may be heated.

According to an embodiment, to prevent the microwave generated in the oscillator 210 from being absorbed into the resonator 220, the resonator 220 may include a material having a low microwave absorbance.

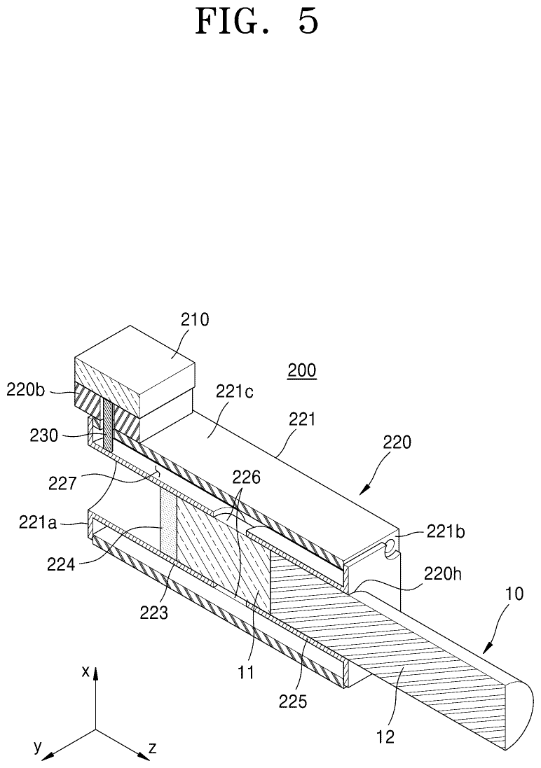

Hereinafter, a detailed structure of the resonator 220 of the heater assembly 200 will be described with reference to FIG. 5.

FIG. 5 illustrates a cross-sectional view of the heater assembly 200 illustrated in FIG. 4. FIG. 5 illustrates a cross-section of the heater assembly 200 illustrated in FIG. 4, taken in an A-A′ direction.

Referring to FIG. 5, the heater assembly 200 according to an embodiment may include the oscillator 210, the resonator 220, and a coupler 230. The components in the heater assembly 200 may be identical or similar to at least one of components in the heater assembly 200 illustrated in FIG. 4, and hereinafter, same descriptions thereof will not be repeatedly given.

As an alternating voltage is applied, the oscillator 210 may generate a microwave in a determined frequency band, and the microwave generated in the oscillator 210 may be delivered to the resonator 220 through the coupler 230.

According to an embodiment, in a process of using the aerosol generating device 100, the oscillator 210 may be fixed to the resonator 220 to prevent separation from the resonator 220. In an example, the oscillator 210 may be fixed onto the resonator 220 by being supported by a bracket 220b protruding in an x direction in an area of the resonator 220. In another example, the resonator 220 may also be fixed onto the resonator 220 in a manner of being attached onto an area of the resonator 220 without the bracket 220b.

Although FIG. 5 only illustrates an embodiment in which the oscillator 210 is fixed to the area in the x direction of the resonator 220, a position of the oscillator 210 is not limited to the embodiment illustrated in FIG. 5. In another embodiment, the oscillator 210 may also be fixed to another area in a-z direction of the resonator 220.

The resonator 220 may be arranged to surround at least an area of the aerosol generating article 10 inserted into the aerosol generating device, and may heat the aerosol generating article 10 by using the microwave generated in the oscillator 210. For example, dielectric materials included in the aerosol generating article 10 may generate heat due to an electric field generated in the resonator 220 due to the microwave, and the aerosol generating article 10 may be heated by the heat generated in the dielectric material.

According to an embodiment, the aerosol generating article 10 may include a tobacco rod 11 and a filter rod 12.

The tobacco rod 11 may include an aerosol generating material, and may be manufactured with a sheet, strands, or cut fillers obtained by finely cutting a tobacco sheet. For example, the aerosol generating material may include at least one of glycerin, propylene glycol, ethylene glycol, dipropylene glycol, diethylene glycol, triethylene glycol, tetraethylene glycol, and oleyl alcohol, but is not limited thereto. In addition, the tobacco rod 11 may include other additive materials such as a savoring agent, a wetting agent, and/or an organic acid. In addition, flavoring liquid such as menthol or moisturizer may be added to the tobacco rod 11 in a manner of being sprayed to the tobacco rod 11.

The filter rod 12 may include a cellulose acetate filter. A shape of the filter rod 12 is not limited. For example, the filter rod 12 may include a cylinder type rod or a tube type rod including a hollow therein. In addition, the filter rod 12 may also include a recess type rod. When the filter rod 12 includes a plurality of segments, at least one of the plurality of segments may be manufactured in another shape.

At least a portion (e.g., glycerin) of the aerosol generating material included in the aerosol generating article 10 may include a dielectric material having polarity in the electric field, and the at least the portion of the aerosol generating material may heat the aerosol generating article 10 by generating heat by the dielectric heating method.

According to an embodiment, the resonator 220 may include an outer conductor 221, a first inner conductor 223, and a second inner conductor 225.

The outer conductor 221 may form an entire outward appearance of the resonator 220, and as an inner portion of the outer conductor 221 is formed in a hollow shape, the components of the resonator 220 may be arranged in the outer conductor 221. The outer conductor 221 may include the accommodation space 220h in which the aerosol generating article 10 may be accommodated, and the aerosol generating article 10 may be inserted into the outer conductor 221 through the accommodation space 220h.

According to an embodiment, the outer conductor 221 may include a first surface 221a, a second surface 221b arranged to face the first surface 221a, and a side surface 221c surrounding an empty space between the first surface 221a and the second surface 221b. At least some (e.g., the first inner conductor 223 and the second inner conductor 225) of the components of the resonator 220 may be arranged in the inner space of the resonator 220 formed by the first surface 221a, the second surface 221b, and the side surface 221c.

The first inner conductor 223 may be formed in a hollow cylinder shape extending in a direction from the first surface 221a of the outer conductor 221 toward the inner space of the outer conductor 221.

According to an embodiment, an area of the first inner conductor 223 may be in contact with the coupler 230 connected to the oscillator 210, and the microwave generated in the oscillator 210 may be delivered to the first inner conductor 223 through the coupler 230. For example, the coupler 230 may be arranged to penetrate the outer conductor 221 and be in contact with the oscillator 210 by an end of the coupler 230 and in contact with an area of the first inner conductor 223 by another end of the coupler 230, and the microwave generated in the oscillator 210 may be delivered to the first inner conductor 223 through the coupler 230.

In this case, to deliver the microwave, the coupler 230 may be arranged to penetrate the outer conductor 221 without being in contact with the outer conductor 221. However, as long as the microwave generated in the oscillator 210 may be delivered to the first inner conductor 223, an arrangement structure of the coupler 230 may be not limited thereto.

A first area formed between the outer conductor 221 and the first inner conductor 223 may be configured to operate as a ‘first resonator’ configured to generate an electric field through resonance of the microwave. The first area may refer to a space formed by the first surface 221a of the outer conductor 221, the side surface 221c, and the first inner conductor 223, and in the first area, an electric field may be generated as a result of resonance of the microwave delivered through the coupler 230.

The second inner conductor 225 may be formed in a hollow cylinder shape extending in a direction from the second surface 221b of the outer conductor 221b into the inner space of the outer conductor 221. In the inner space of the outer conductor 221, the second inner conductor 225 may be arranged apart by a certain distance from the first inner conductor 223, and a gap 226 may be formed between the first inner conductor 223 and the second inner conductor 225.

The second area formed between the outer conductor 221 and the second inner conductor 225 may be configured to operate as a ‘second resonator’ configured to generate an electric field through resonance of the microwave. The second inner conductor 225 and the first inner conductor 223 may be in a coupling (e.g., a capacitive coupling), and due to this coupling relationship, when an electric field is generated in the first area, an induced electric field may be formed in the second area. In the disclosure, ‘a capacitive coupling’ may indicate a coupling relationship in which energy may be delivered due to a capacitance between two conductors.

For example, as the microwave generated from the oscillator 210 is delivered to the first inner conductor 223, an electric field may be formed in the first area as a result of the resonance, and an induced electric field may be generated in the second area formed by the second inner conductor 225 coupled with the outer conductor 221 and the first inner conductor 223.

According to an embodiment, the first area and the second area of the resonator 220 may be configured to operate as a resonator having a ¼ (λ) wavelength of the microwave.

In an embodiment, an end (e.g., an end in the-z direction) of the first area may be formed in a short end as a cross-section of the first area is closed by the first surface 221a of the outer conductor 221, and another end (e.g., an end in the z direction) of the first area may be formed in an open end as the first surface 221a is not arranged and a cross-section of the other end of the first area is open. In another example, an end (e.g., an end in the-z direction) of the second area may be formed in an open end as an end surface of the second area is open, and another end (e.g., an end in the z direction) may be formed in a short end as a cross-section of the second area is closed by the second surface 221b of the outer conductor 221.

That is, on an xz plane, the first area and the second area each including the short end and the open end may be formed in a shape of the Korean letter “ [symbol] ”, and through the aforementioned structure, the first area and the second area may each operate as a resonator having a ¼ wavelength of the microwave.

According to an embodiment, the first inner conductor 223 and the second inner conductor 225 may be formed in a same length with reference to a z axis and may be arranged such that the first area and the second area are symmetric, but the disclosure is not limited thereto.

The aerosol generating article 10 inserted into the inner space of the outer conductor 221 through the accommodation space 220h may be surrounded by the first inner conductor 223 and the second inner conductor 225 and heated in the dielectric heating method.

At least a portion of the electric field generated due to the resonance of the microwave in the first area and/or the second area may be propagated into the first inner conductor 223 and/or the second inner conductor 225 through the gap 226 between the first inner conductor 223 and the second inner conductor 225, and the aerosol generating article 10 surrounded by the first inner conductor 223 and the second inner conductor 225 may be heated by the electric field that has been propagated. For example, the dielectric material included in the aerosol generating article 10 may generate heat due to the electric field propagated through the gap 226, and the aerosol generating article 10 may be heated due to the heat generated from the dielectric material.

In the heater assembly 200 according to an embodiment, by setting diameters of the first inner conductor 223 and the second inner conductor 225 to have a value less than a determined value, it is possible to prevent leakage of the electric field, which has been propagated into the first inner conductor 223 and/or the second inner conductor 225, to the outside of the heater assembly 200 or the resonator 220. In the disclosure, the term ‘determined value’ may indicate a value of the diameters of the first inner conductor 223 and the second inner conductor 225 at which the electric field begins to leak outside of the first inner conductor 223 and/or the second inner conductor 225. For example, when the value of the diameter of the first inner conductor 223 and/or the second inner conductor 225 is equal to or greater than the determined value, a portion of the electric field introduced into the first inner conductor 223 and/or the second inner conductor 225 may leak out to outside of the resonator 220. On the other hand, through a structure in which the value of the diameters of the first inner conductor 223 and the second inner conductor 225 is less than the determined value, the heater assembly 200 according to an embodiment may prevent propagation of the electric field to the outside of the resonator 220, and as a result, leakage of the electric field to the outside of the heater assembly 200 or the resonator 220 may be prevented without additional blocking members.

According to an embodiment, when the aerosol generating article 10 is inserted into the resonator 220 through the accommodation space 220h, the tobacco rod 11 of the aerosol generating article 10 may be arranged at a position corresponding to a position of the gap 226 between the first inner conductor 223 and the second inner conductor 225.

As the electric field generated in the first area and the electric field generated in the second area are introduced into the first inner conductor 223 and/or the second inner conductor 225 through the gap 226, a strongest electric field may be generated in a peripheral area of the gap 226 among inner areas of the resonator 220.

In the heater assembly 200 according to an embodiment, heating efficiency (or ‘dielectric heating efficiency) of the heater assembly 200 may be improved by arranging the tobacco rod 11, which includes the dielectric material generating heat due to the electric field, at a position corresponding to a position of the gap 226 having the strongest electric field.

According to an embodiment, the resonator 220 may further include a closing unit 224 located in the first inner conductor 223 and limiting a direction in which the aerosol generated from the aerosols generating article 10 moves by closing a cross-section of the first inner conductor 223. For example, the closing unit 224 may prevent movement in the −z direction of the aerosols generated from the aerosol generating article 10 by closing the cross-section of the first inner conductor 223.

As the aerosols generated from the aerosol generating article 10 or a droplet generated as a result of liquefaction of the aerosols move in the −z direction and are introduced into another component of the aerosol generating device (e.g., the aerosol generating device 100 illustrated in FIG. 1), misoperation or damage may be caused to the components of the aerosol generating device. On the other hand, in the heater assembly 200 according to an embodiment, misoperation or damage of the components of the aerosol generating device due to the aerosols or droplet may be prevented by limiting the direction in which the aerosols move through the closing unit 224.

According to an embodiment, the resonator 220 may further include a dielectric material-accommodation space 227 for accommodating the dielectric material. The dielectric material-accommodation space 227 may indicate an empty space between the outer conductor 221 and the first inner conductor 223 and the second inner conductor 225, and a dielectric material having a low microwave absorbance may be accommodated in the dielectric material-accommodation space 227. For example, the dielectric material may include at least one of quartz, tetrafluoroethylene, and aluminum oxide, or a combination thereof, but is not limited thereto.

In the heater assembly 200 according to an embodiment, by arranging the dielectric material in the dielectric material-accommodation space 227, the electric field identical to an electric field of the resonator 220 and not including the dielectric material may be generated while reducing an entire size of the resonator 220. That is, in the heater assembly 200 according to an embodiment, a mounting space of the resonator 220 in the aerosol generating device may be reduced by reducing the size of the resonator 220 through the dielectric material arranged in the dielectric material-accommodation space 227, and as a result thereof, the size of the aerosol generating device 100 may be reduced.

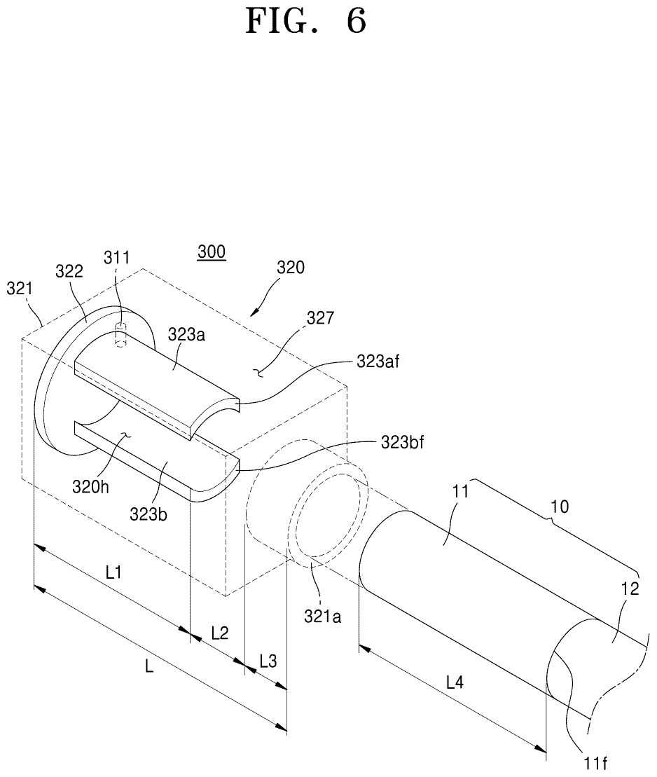

FIG. 6 is a perspective view schematically illustrating a heater assembly 300 according to another embodiment.

The heater assembly 300 according to the embodiment in FIG. 6 may include a resonator 320 configured to cause microwave resonance and a coupler 311 configured to provide a microwave to the resonator 320.

The resonator 320 may include a case 321, a plurality of plates 323a and 323b, and a connector 322 connecting the plurality of plates 323a and 323b and the case 321.

The coupler 311 may be configured to provide the microwave to at least one of the plurality of plates 323a and 323b such that the resonator 320 generates the microwave resonance.

The resonator 320 may include at least one area of the aerosol generating article 10 inserted into the aerosol generating device. The coupler 311 may be configured to provide the microwave generated by the oscillator (not shown) to the resonator 320. When the microwave is provided to the resonator 320, the microwave resonance occurs in the resonator 320, and thus, the resonator 320 may heat the aerosol generating article 10. For example, the dielectric materials included in the aerosol generating article 10 may generate heat due to an electric field generated in the resonator 320 due to the microwave, and the aerosol generating article 10 may be heated by heat generated from the dielectric materials.

The case 321 of the resonator 320 functions as ‘an outer conductor’. As the case 321 is formed in a hollow shape, components of the resonator 320 may be arranged in the case 321.

The case 321 may include an accommodation space 320h, in which the aerosol generating article 10 may be accommodated, and an opening 321a through which the aerosol generating article 10 may be inserted. The opening 321a is connected to the accommodation space 320h. As the opening 321a is open toward outside of the case 321, the accommodation space 320h is connected to the outside through the opening 321a. Accordingly, the aerosol generating article 10 may be inserted into the accommodation space 320h of the case 321 through the opening 321a of the case 321.

Although the case 321 has a cross-section of a square shape, the shape of the case 321 may be modified into various forms. For example, a structure of the case 321 may be modified to have various shapes of the cross-section, e.g., a rectangle, an oval, or a circle. The case 321 may extend in a direction.

The plurality of plates 323a and 323b that may function as ‘inner conductors’ of the resonator 320 may be arranged in the case 321.

The plurality of plates 323a and 323b may be arranged apart from each other in a circumferential direction of the aerosol generating article 10 accommodated in the accommodation space 320h. The plurality of plates 323a and 323b may include a first plate 323a, which is arranged to surround an area of the aerosol generating article 10, and a second plate 323b arranged to surround another area of the aerosol generating article 10.

The plurality of plates 323a and 323b may be connected to the case 321 through the connector 322. In addition, an end of the first plate 323a and an end of the second plate 323b in the plurality of plates 323a and 323b may be connected to each other through the connector. Accordingly, a closed end portion closed by the connector 322 may be formed at the end of each of the plurality of plates 323a and 323b.

Another end 323af of the first plate 323a and another end 323bf of the second plate 323b in the plurality of plates 323a and 323b may be open by being separate from each other. As the other ends of the plurality of plates 323a and 323b are separate from each other, an open end portion may be formed at the other end of each of the plurality of plates 323a and 323b.

As the plurality of plates 323a and 323b and the connector 322 are connected, a resonator assembly may be complete. A shape of a cross-section cut along a longitudinal direction of the resonator assembly may have a horseshoe-shape.

The plurality of plates 323a and 323b extend in a longitudinal direction of the aerosol generating article 10. At least a portion of the plurality of plates 323a and 323b may be bent to protrude outward from a center of the aerosol generating article 10 in the longitudinal direction.

For example, when the aerosol generating article 10 is manufactured in a cylinder shape, the plurality of plates 323a and 323b may be bent in a circumferential direction along an outer circumferential surface of the aerosol generating article 10. A radius of curvature of the cross-section of each of the plurality of plates 323a and 323b may be identical to a radius of curvature of the aerosol generating article 10. The radius of curvature of the cross-section of each of the plurality of plates 323a and 323b may be variously modified. For example, the radius of curvature of the cross-section of each of the plurality of plates 323a and 323b may be greater or less than the radius of curvature of the aerosol generating article 10.

According to the structure in which the plurality of plates 323a and 323b are bent in the circumferential direction along the outer circumferential surface of the aerosol generating article 10, a more uniform electric field is formed in the resonator 320, and therefore, the heater assembly 300 may uniformly heat the aerosol generating article 10.

The open end portions of the other ends of the plurality of plates 323a and 323b may be arranged to face the opening 321a of the case 321. The opening 321a of the case 321 may be arranged apart in a direction away from the end portions of the other ends of the plurality of plates 323a and 323b.

The open end portions of the other ends of the plurality of plates 323a and 323b may be aligned with respect to the opening 321a of the case 321. Accordingly, when the aerosol generating article 10 is inserted through the opening 321a of the case 321 and located in the accommodation space 320h, a portion of the aerosol generating article 10 in the accommodation space 320h may be surrounded by the plurality of plates 323a and 323b.

The plurality of plates 323a and 323b are arranged in the number of two at positions opposite to each other around the center of the aerosol generating article 10 in the longitudinal direction. The embodiments are not limited to the number of the plurality of plates 323a and 323b, and the number of the plurality of plates 323a and 323b may be, for example, three or not less than four.

The plurality of plates 323a and 323b may be arranged to be in symmetry with each other around a central axis in the longitudinal direction of the aerosol generating article 10, that is, the central axis of a direction in which the aerosol generating article 10 extends.

At least one of the plurality of plates 323a and 323b may be in contact with the coupler 311 connected to the oscillator (not shown). More particularly, at least a portion of the first plate 323a may be in contact with the coupler 311. When the microwave is delivered to the first plate 323a through the coupler 311, resonance of the microwave is generated between the plurality of plates 323a and 323b. In addition, resonance of the microwave is generated between the first plate 323a and an upper plate of the case 321 and between the second plate 323b and a lower plate of the case 321. Accordingly, an electric field may be formed in each of between the plurality of plates 323a and 323b and the connector 322, between the first plate 323a and the upper plate of the case 321, and between the second plate 323b and the lower plate of the case 321.

As the coupler 311 may penetrate through the case 321, an end of the coupler 311 may be in contact with the oscillator (not shown), and another end of the coupler 311 may be in contact with an area of the first plate 323a. As the microwave generated in the oscillator (not shown) is delivered to the plurality of plates 323a and 323b and the connector 322 through the coupler 311, an electric field may be formed in an assembly of the plurality of plates 323a and 323b and the connector 322.

In addition, according to a structure of the resonator 320 of the heater assembly 300, a triple resonance mode may be formed in the resonator 320. Resonance in a transverse electric & magnetic (TEM) mode of a microwave is formed between the plurality of plates 323a and 323b. In addition, resonance in the TEM mode different from the resonance generated between the plurality of plates 323a and 323b is formed in each of between the first plate 323a and the upper plate of the case 321 and between the second plate 323b and the lower plate of the case 321. As the resonator 320 illustrated in FIG. 6 may resonate in the TEM mode by the plurality of plates 323a and 323b, and thus may be manufactured in a size smaller than the size of the resonator 220 illustrated in FIG. 5, which may resonate only in a transverse electric (TE) mode and a transverse magnetic (TM) mode.

As triple resonance is generated in the resonator 320 of the heater assembly 300, the aerosol generating article 10 may be more efficiently and uniformly heated.

The resonator 320 according to the aforementioned embodiment may include a short end and an open end. A cross-section of the short end is closed to have a ¼ length (λ/4) of the wavelength of the microwave, the open end is opposite to the short end, and at least an area of a cross-section of the open end is open.

In FIG. 6, an area at an end of the resonator 320 corresponding to a left area forms the short end closed by a structure in which an end of each of the plurality of plates 323a and 323b and the connector 322 are connected to the case 321. In FIG. 6, an area of another end of the resonator 320 corresponding a right area forms the open end as the opening 321a of the case 321 is open outside. Due to the structure of the resonator 320, the resonator 320 may operate as a resonator having a wavelength corresponding to ¼ of the wavelength of the microwave.

According to the aforementioned resonance structure of the resonator 320, an electric field may be not propagated to an area outside of the resonator 320. Accordingly, the heater assembly 300 may prevent the electric field from leaking to the outside of the heater assembly 300 even without an additional blocking member for blocking the electric field.

The aerosol generating article 10 inserted into the accommodation space 320h of the case 321 may be surrounded by the first plate 323a and the second plate 323b and heated in the dielectric heating method. For example, a portion including a medium of the aerosol generating article 10 inserted into the accommodation space 320h of the case 321 may be arranged in a space between the first plate 323a and a second plate 323b. The electric field generated in the space between the first place 323a and the second plate 323b causes the dielectric material included in the aerosol generating article 10 to generate heat, and thus, the aerosol generating article 10 may be heated.

In addition, an action of an electric field caused by a resonance mode generated in each of between the first plate 323a and the upper plate of the case 321 and between the second plate 323b and the lower plate of the case 321 may cause a secondary heating action on the aerosol generating article 10.

When the aerosol generating article 10 is inserted into the resonator 320 through the accommodation space 320h, the tobacco rod 11 of the aerosol generating article 10 may be between the plurality of plates 323a and 323b.

A length L4 of the tobacco rod 11 may be greater than a length L1 of the plurality of plates 323a and 323b. Accordingly, a front end portion 11f of the tobacco rod 11 being in contact with the filter rod 12 is at a position protruded compared with the other end 323af of the first plate 323a and the other end 323bf of the second plate 323b.

A resonance peak may be formed at the other ends of the plurality of plates 323a and 323b operating as the resonator, and therefore, an electric field stronger than electric fields in other areas may be generated. The tobacco rod 11, which includes the dielectric material capable of generating heat due to the electric field when the aerosol generating article 10 is inserted into the heater assembly, is arranged to correspond to an area having the strongest electric field, and by doing so, heating efficiency (or ‘dielectric heating efficiency’) of the heater assembly 300 may be improved.

Referring to FIG. 6, the length L1 of the plurality of plates 323a and 323b may be set less than a length L1+L2 of the inner space of the case 321. Accordingly, the other ends of the plurality of plates 323a and 323b may be located at inner position of the case 321 compared with the opening 321a. That is, the other ends of the plurality of plates 323a and 323b may be located apart by a distance L2 from a back end portion of the opening 321a.

A length from the back end portion of the opening 321a, at which the opening 321a is connected to the case 321, to the front end portion of the opening 321a at which the opening 321a is open may be L3. A total length of the case 321 in a longitudinal direction of the case 321 may be L. The total length L of the case 321 may be determined according to a sum of the length L1 of the plurality of plates 323a and 323b, the length L2 by which the plurality of plates 323a and 323b and the back end portion of the opening 321a are apart from each other, and the length L3 in which the opening 321a protrudes from the case 321.

To prevent leakage of the microwave, the front end portion of the opening 321a at which the opening 321a is open protrudes in the length L3 from the case 321. As the opening 321a of the case 321 protrudes from the case 321, the opening 321a may prevent the microwave in the case 321 of the resonator 320 from leaking to the outside of the case 321.

The resonator 320 may further include a dielectric material-accommodation space 327 for accommodating the dielectric materials. The dielectric material-accommodation space 327 may be formed in an empty space between the case 321 and the plurality of plates 323a and 323b. A dielectric material having a low microwave absorbance may be accommodated in the dielectric material-accommodation space 327.

In the heater assembly 300, as the dielectric materials are arranged in the dielectric material-accommodation space 327, an electric field at a same level as an electric field generated in a resonator not including the dielectric materials may be generated while reducing an entire size of the resonator 320. That is, by reducing a size of the resonator 320 through the dielectric materials arranged in the dielectric material-accommodation space 327, a mounting space of the resonator 320 in the aerosol generating device may be reduced, and as a result thereof, the size of the aerosol generating device 100 may be reduced.

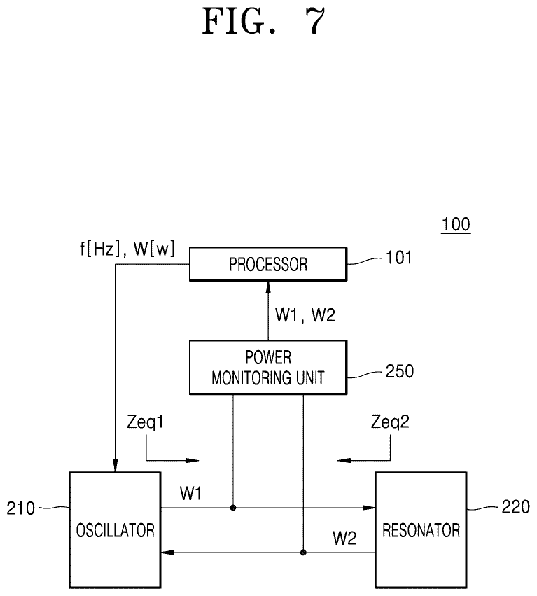

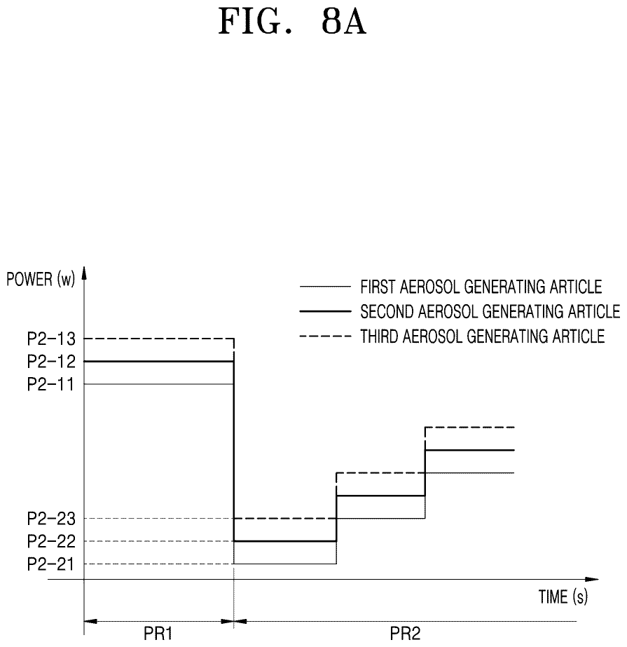

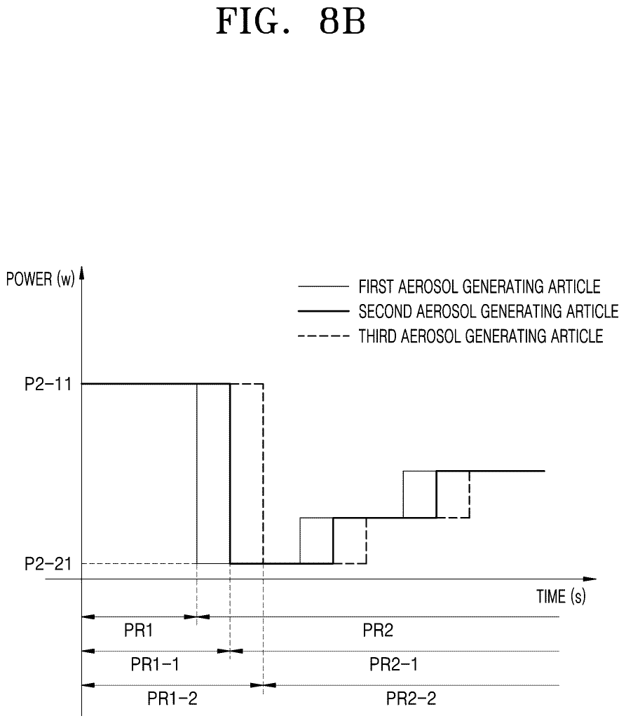

FIG. 7 is a block diagram of the aerosol generating device 100 according to an embodiment. FIGS. 8A and 8B are diagrams for describing look-up tables including power profiles respectively corresponding to a plurality of aerosol-generating articles.

Among the components included in the aerosol generating device 100 illustrated in FIGS. 2 to 4, FIG. 7 only illustrates components for adjusting intensity and a frequency of microwave power among outputs of the oscillator 210. Therefore, same descriptions as the descriptions with reference to FIGS. 2 to 4 will not be given.

Referring to FIGS. 3 and 5 to 7, the aerosol generating device 100 may include the oscillator 210, the power monitoring unit 250, the resonator 220, and the processor 101.

The oscillator 210 may be configured to output a microwave having a frequency within a preset range and power with preset intensity, under control of the processor 101. The oscillator 210 may include at least one switching device, and the processor 101 may change an output frequency of the microwave by adjusting on/off of the switching device. For example, the processor 101 may be configured to control the oscillator 210 to output a microwave having any one output frequency selected from a range from 2.4 GHz to 2.5 GHz or a range from 5.7 GHz to 5.9 GHz.

In addition, the oscillator 210 may include a power amplifier, and under control of the processor 101, the power amplifier may control intensity of power of the microwave being output by increasing or decreasing an amplitude of the microwave. For example, the processor 101 may be configured to control the oscillator 210 to output a microwave having any one power intensity selected from a range from 3 W to 20 W.

The microwave output from the oscillator 210 may be output to the resonator 220.

The resonator 220 may accommodate the aerosol generating article 10 and may heat the aerosol generating article 10 by resonating the microwave provided from the oscillator 210. An internal structure of the resonator 220 may be identical to the structure illustrated in FIGS. 4 to 6.

The power monitoring unit 250 may be configured to measure an incident microwave W1 output from the oscillator 210 or a reflected microwave W2 reflected from the resonator 220 and input to the oscillator 210. In an embodiment, intensity of the incident microwave W1 may correspond to intensity of power output from the oscillator 210 and input to the resonator 220, and intensity of the reflected microwave W2 may correspond to intensity of power reflected from the resonator 220 and input to the oscillator 210.

The aerosol generating article 10 may include the tobacco rod 11 and the filter rod 12, and the tobacco rod 11 may include the aerosol generating material. The aerosol generating material may be manufactured in forms of a sheet, a strand, or cut fillers, and a type of the aerosol generating material may include at least one of glycerin, propylene glycol, ethylene glycol, dipropylene glycol, diethylene glycol, triethylene glycol, tetraethylene glycol, and oleyl alcohol. In addition, the tobacco rod 11 may further include at least one of a savoring agent, a wetting agent, an organic acid, and flavoring liquid.

The aerosol generating article 10 may include dielectric materials such as the aerosol generating material, a savoring agent, a wetting agent, an organic acid, and flavoring liquid, and a permittivity of the dielectric material included in the tobacco rod 11 may vary according to the type of the aerosol generating article 10. Therefore, the permittivity of the dielectric material of the resonator 220 may vary according to the type of the aerosol generating article 10 inserted into the resonator 220. That is, impedance of the resonator 220 may vary according to the type of the aerosol generating article 10 inserted into the resonator 220. Even when the incident microwave W1 incident on the resonator 220 is constant, intensity of the reflected microwave W2 may be different, because the degree of reflection varies when the impedance of the resonator 220 varies.

When the oscillator 210 is controlled with a fixed output despite that the impedance of the resonator 220 is different, a first impedance Zeq1 from the resonator 210 to the resonator 220 and a second impedance Zeq2 from the resonator 220 to the oscillator 210 may not match. That is, the first impedance Zeq1 and the second impedance Zeq2 may not match each other. In addition, as impedance matching is related to maximum power delivery conditions, the maximum power delivery conditions may be not satisfied. When the maximum power delivery conditions are not satisfied, the aerosol generating device 100 may not exhibit optimized vaporizing performance.

Hereinafter, a configuration to adjust intensity of the microwave output to the oscillator 210 based on different power profiles according to the type of the aerosol generating article 10 will be described in detail.

First, in the standby mode, the aerosol generating device 100 may identify whether the aerosol generating article 10 has been inserted into the accommodation space 220h (see FIG. 4).

The processor 101 according to an embodiment may identify whether the aerosol generating article 10 has been inserted into the accommodation space 220h (see FIG. 4) by using the insertion sensor of the sensor 104 (see FIG. 2). In this case, the insertion sensor may include at least one of a film sensor, a pressure sensor, an optical sensor, a resistive sensor, a capacity sensor, an inductive sensor, and an infrared ray sensor.

The processor 101 according to another embodiment may also be configured to identify whether the aerosol generating article 10 has been inserted, based on the reflected microwave W2. When the intensity of the reflected microwave W2 is less than a first threshold value, the processor 101 may determine that the aerosol generating article 10 has been inserted into the accommodation space 220h of the resonator 220. In this case, the first threshold value may be determined according to the permittivity and an amount of the dielectric material included in the aerosol generating article 10. For example, when the permittivity of the aerosol generating article 10 is great, most of the incident microwave W1 is absorbed, and therefore, the first threshold value may be inversely proportional to the dielectric constant of the aerosol generating article 10. The first threshold value may be experimentally calculated. The first threshold value may be stored in advance in the memory 106.

When insertion of the aerosol generating article 10 is sensed, the processor 101 may output the incident microwave W1 by using the oscillator 210 and measure, by using the power monitoring unit 250, the reflected microwave W2 reflected from the resonator 220 and input to the oscillator 210. In this case, the processor 101 may receive the incident microwave W1 and the reflected microwave W2 measured by the power monitoring unit 250.

Next, the processor 101 may determine the type of the aerosol generating article 10, based on the measured reflected microwave W2. The aerosol generating device 100 according to an embodiment may include the memory 106 (see FIG. 2) in which the relationships between the plurality of reflected microwaves W2 and the aerosol generating articles 10 are stored in forms of look-up tables.

Each of the plurality of aerosol generating articles 10 may have a permittivity of the dielectric material fixed according to a composition of the tobacco rod 11. Accordingly, the plurality of aerosol generating articles 10 may have different intensity of reflected microwave W2, in response to same intensity of incident microwave W1.

For example, referring to FIG. 8A, the plurality of aerosol generating articles 10 may include a first aerosol generating article, a second aerosol generating article, and a third aerosol generating article. In this case, dielectric constants of the dielectric materials included in the aerosol generating articles 10 may be great in orders of the third aerosol generating article, the second aerosol generating article, and the first aerosol generating article (that is, the first aerosol generating article has a least permittivity, and the third aerosol generating article has a greatest permittivity). As the aerosol generating article 10 having a greater permittivity is to absorb a greater amount of the incident microwave W1, intensity of the reflected microwave W2 with respect to the incident microwave W1 having same intensity may be great in orders of the first aerosol generating article, the second aerosol generating article, and the third aerosol generating article (that is, the reflected microwave W2 with respect to the first aerosol generating article is greatest, and the reflected microwave W2 with respect to the third aerosol generating article is least).

Next, in the heating mode, the processor 101 may adjust the intensity of the microwave power output from the oscillator 210, based on the power profile corresponding to the type of the aerosol generating article 10 determined in the standby mode.

The aerosol generating device 100 according to an embodiment may include the memory 106 (see FIG. 2) in which the relationships between the plurality of aerosol generating articles 10 (or the intensity of the reflected microwave W2) and power profiles are stored in forms of look-up tables. That is, the look-up tables stored in the memory 106 (see FIG. 2) may include a first look-up table including the aerosol generating article 10 corresponding to the intensity of the reflected microwave W2 and a second look-up table including the power profiles corresponding to the plurality of aerosol generating articles 10. However, the look-up tables are not limited thereto, and may only include a look-up table including power profiles corresponding to the intensity of the reflected microwave W2.

For example, referring to FIG. 8A, a first heating profile corresponding to the first aerosol generating article may include target temperature information (or target power information) according to a pre-heating period PR1 and a smoking period PR2, the oscillator 210 may provide the microwave power as 2-11 power in the pre-heating period PR1 and provide the microwave power as 2-21 power less than the 2-11 power in the smoking period PR2. The processor 101 may be configured to progressively increase the intensity of the microwave power in the smoking period PR2.

In addition, a second heating profile corresponding to the second aerosol generating article may include target temperature information (or target power information) according to the preheating period PR1 and the smoking period PR2, the oscillator 210 may provide the microwave power as 2-12 power in the pre-heating period PR1 and provide the microwave power as 2-22 power less than the 2-12 power in the smoking period. The processor 101 may be configured to progressively increase the intensity of the microwave power in the smoking period PR2.

Likewise, a third heating profile corresponding to the third aerosol generating article may include target temperature information (or target power information) according to the pre-heating period PR1 or the smoking period PR2, the oscillator 210 may provide the microwave power as 2-13 power in the pre-heating period and provide the microwave power as 2-23-power less than the 2-13 power in the smoking period PR2. The processor 101 may be configured to progressively increase the intensity of the microwave power in the smoking period PR2.

Here, it is required that the heating object having a greater permittivity is heated at a higher temperature, therefore, the intensity of the microwave power may be set great in orders of the 2-13 power, the 2-12 power, and the 2-11 power, and great in orders of the 2-23 power, the 2-22 power, and the 2-21 power.

However, the heating profile is not limited to a component configured to adjust a target temperature by adjusting the intensity of the power. For example, as illustrated in FIG. 8B, in the heating profile, the target temperature may also be adjusted by adjusting a pre-heating time period.

More particularly, referring to FIG. 8B, the first heating profile corresponding to the first aerosol generating article may include the target temperature information (or the target power information) corresponding to the pre-heating period PR1 and the smoking period PR2, the oscillator 210 may provide the microwave power as the 2-11 in the pre-heating period and provide the microwave power as the 2-21 power less than the 2-11 in the smoking period PR2. The processor 101 may be configured to progressively increase the intensity of the microwave power in the smoking period PR2.

In addition, the second heating profile corresponding to the second aerosol generating article may include the target temperature information (or the target power information) according to a pre-heating period PR1-1 and a smoking period PR2-1. However, the pre-heating period PR1-1 of the second heating profile may be longer than the pre-heating period PR1 of the first heating profile.

The oscillator 210 may provide the microwave power as the 2-11 power in the pre-heating power PR1-1, like in the pre-heating period PR1 of the first heating profile, and may provide the microwave power as the 2-21 power in the smoking period PR2-1, like in the smoking period PR2 of the first heating profile. The processor 101 may be configured to progressively increase the intensity of the microwave power in the smoking period PR2-1.

Likewise, the third heating profile corresponding to the third aerosol generating article may include the target temperature information (or the target power information) according to the pre-heating period PR1-2 and the smoking period PR2-2. However, the pre-heating period PR1-2 of the third heating profile may be longer than the pre-heating period PR1-1 of the second heating profile.

The oscillator 210 may provide the microwave power as the 2-11 power in the pre-heating period PR1-2, like in the pre-heating period PR1 of the first heating profile, and provide the microwave power as the 2-21 power in the smoking period PR2-1, like in the smoking period PR2 of the first heating profile. The processor 101 may be configured to progressively increase the intensity of the microwave power in the smoking period PR2-2.

In this case, it is required that the heating object (or the aerosol generating article 10) is heated for a longer period as the permittivity of the heating object is greater, the pre-heating periods may be set longer in orders of the pre-heating period PR1-2, the pre-heating period PR1-1, and the pre-heating period PR1.

The processor 101 may determine whether the aerosol generating article 10 is reused, based on the reflected microwave W2 measured in the standby mode.

More particularly, when a value of the reflected microwave W2 measured in the standby mode is equal to or greater than a preset threshold value, the processor 101 may stop generation of the microwave in the oscillator 210. That is, due to exhaustion of the aerosol generating materials and the like included in the tobacco rod 11, the aerosol generating article 10 that has been reused may have a permittivity significantly less than a permittivity of the aerosol generating article 10 that has not been used. Accordingly, the reflected microwave W2 of the aerosol generating article 10 that has been reused may be greater than the aerosol generating article 10 that has not been used. In this case, the preset threshold value may be calculated in an experiment-statistic manner and stored in advance in the memory 106.

The power monitoring unit 250 according to an embodiment may track real-time change in a resonance frequency of the resonator 220 in the heating mode.

More particularly, as the dielectric material included in the aerosol generating article 10 is heated by the microwave and consumed, the impedance of the resonator 220 may change. When the oscillator 210 is controlled with a fixed output even when the impedance of the resonator 220 changes, the first impedance Zeq1 from the resonator 210 to the resonator 220 and the second impedance Zeq2 from the resonator 220 to the oscillator 210 may not match. That is, the first impedance Zeq1 and the second impedance Zeq2 may not match each other. In addition, as impedance matching is related to maximum power delivery conditions, the maximum power delivery conditions may be not satisfied. In the heating mode, to match the first impedance Zeq1 and the second impedance Zeq2, the power monitoring unit 250 may measure power output from the oscillator 210 and input to the resonator 220 and power reflected from the resonator 220 and input to the oscillator 210.

The processor 101 may adjust an output frequency of the oscillator 210 such that a difference between the power output from the oscillator 210 and input to the resonator 220 and power reflected from the resonator 220 and input to the oscillator 210 is included in a preset reference power range. For example, the reference power range may be between 0 w and 1 w, but is not limited thereto.

The processor 101 may sweep the output frequency output from the oscillator 210, within a preset reference band range, and may control the oscillator 210 such that the difference between the power output from the oscillator 210 and input to the resonator 220 and the power reflected from the resonator 220 and input to the oscillator 210 is included in a preset range. For example, the reference band range may be from 2.4 GHz to 2.5 GHz or from 5.7 GHz to 5.9 GHZ, but is not limited thereto.

Adjustment on the output frequency by the processor 101 may be performed in real time. In other words, the processor 101 may adjust the output frequency of the resonator 210 independently of adjustment on the intensity of the power of the oscillator 210 described above. That is, the processor 101 may control the intensity of the microwave power output from the oscillator 210 according to the power profile corresponding to the type of the aerosol generating article 210 described above, regardless of the adjustment on the output frequency of the oscillator 210.

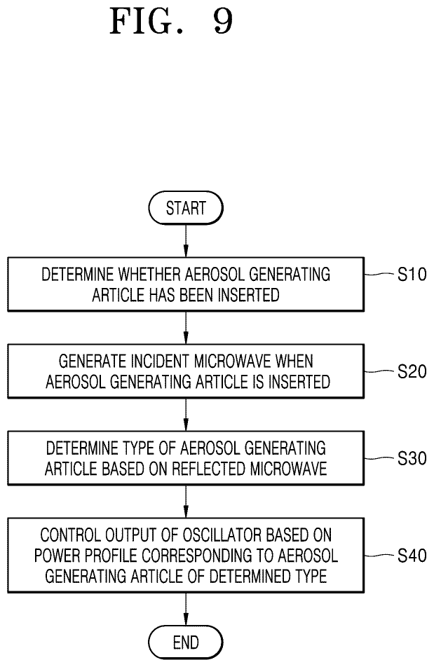

FIG. 9 is a flowchart for describing an operation method of the aerosol generating device 100 using a dielectric heating method. It is obvious that the embodiments described above with reference to FIGS. 1 to 8B, as well as the embodiment illustrated in FIG. 9, may be applied to an operation method of the aerosol generating device 100.

Referring to FIGS. 1 to 9, the operation method of the aerosol generating article 10 including the oscillator 210 configured to generate the microwave, the resonator 220 including the accommodation space 220h for accommodating the aerosol generating article 10, the resonator 220 configured to resonate microwave and heat the aerosol generating article, may include, identifying whether the aerosol generating article 10 is inserted into the accommodation space 220h (S10), generating the incident microwave W1 output from the oscillator 210 and input to the resonator 220 in response to the identifying of insertion of the aerosol generating article 10 (S20), and measuring the reflected microwave W2 reflected from the resonator 220 and input to the oscillator 210 and determining the type of the aerosol generating article based on the measured reflected microwave W2 (S30), and adjusting the intensity of the microwave power output from the oscillator 210 in the heating mode according to the power profile corresponding to the aerosol generating article 10 determined in the standby mode (S40).

The processor 101 may be configured to adjust the intensity of the microwave power output from the oscillator 210, based on an operation mode of the aerosol generating device 100. For example, the aerosol generating device 100 may be configured to operate in a standby mode and a heating mode. The standby mode indicates a state that the aerosol generating device 100 is power-on but the heater assembly 200 (or the dielectric heater) does not perform a heating operation. The heating mode, in which the heater assembly 200 performs the heating operation, may be divided into the pre-heating period and the smoking period.

The oscillator 210 may provide the microwave power as first power in the standby mode (e.g., S10, S20, and S30) and provide the microwave power as second power greater than the first power in the heating mode (e.g., S40).

In detail, the processor 101 may identify whether the aerosol generating article 10 has been inserted into the accommodation space 220h (see FIG. 4) by using the insertion sensor of the sensor 104 (see FIG. 2) under the standby mode (S10). In this case, the insertion sensor may include at least one of a film sensor, a pressure sensor, an optical sensor, a resistive sensor, a capacity sensor, an inductive sensor, and an infrared ray sensor.

Next, when insertion of the aerosol generating article 10 is sensed under the standby mode, the processor 101 may output the incident microwave W1 by using the oscillator 210 (S20).

Next, under the standby mode, the processor 101 may measure the reflected microwave W2 reflected from the resonator 220 and input to the oscillator 210, by using the power monitoring unit 250, and determine the type of the aerosol generating article 10 based on the measured reflected microwave W2 (S30). The aerosol generating device 100 according to an embodiment may include the memory 106 (see FIG. 2) in which the relationship between the intensity of the reflected microwave W2 and the power profiles is stored in a form of a look-table. Each of the plurality of aerosol generating articles 10 may have a permittivity of the dielectric material fixed according to a composition of the tobacco rod 11. Accordingly, the plurality of aerosol generating articles 10 may have different intensity of reflected microwave W2, in response to same intensity of incident microwave W1.

Next, in the heating mode, the processor 101 may adjust the intensity of the microwave power output from the oscillator 210, based on the power profile corresponding to the type of the aerosol generating article 10 determined in the standby mode (S40).

The aerosol generating device 100 according to an embodiment may include the memory 106 (see FIG. 2) in which relationships between the plurality of aerosol generating articles 10 and the power profiles are stored in the form of a look-up table. For example, referring to FIG. 8A, the first heating profile corresponding to the first aerosol generating article may include target temperature information (or target power information) according to the pre-heating period PR1 and the smoking period PR2, the oscillator 210 may provide the microwave power as 2-11 power in the pre-heating period PR1 and provide the microwave power as the 2-21 power less than the 2-11 power in the smoking period PR2. The processor 101 may be configured to progressively increase the intensity of the microwave power in the smoking period PR2.

In addition, the second heating profile corresponding to the second aerosol generating article may include target temperature information (or target power information) according to the pre-heating period PR1 and the smoking period PR2, the oscillator 210 may provide the microwave power as the 2-12 power in the pre-heating period PR1 and provide the microwave power as the 2-22 power less than the 2-12 power in the smoking period PR2. The processor 101 may be configured to progressively increase the intensity of the microwave power in the smoking period PR2.

Likewise, the third heating profile corresponding to the third aerosol generating article may include target temperature information (or target power information) according to the pre-heating period PR1 or the smoking period PR2, the oscillator 210 may provide the microwave power as the 2-13 power in the pre-heating period and provide the microwave power as the 2-23-power less than the 2-13 power in the smoking period PR2. The processor 101 may be configured to progressively increase the intensity of the microwave power in the smoking period PR2.

Here, it is required that the heating object having a greater permittivity is heated at a higher temperature, therefore, the intensity of the microwave power may be set greater in orders of the 2-13 power, the 2-12 power, and the 2-11 power, and greater in orders of the 2-23 power, the 2-22 power, and the 2-21 power.

The processor 101 may determine whether the aerosol generating article is reused, based on the reflected microwave W2 measured in the standby mode.

More particularly, when the value of the reflected microwave W2 measured in the standby mode is equal to or greater than a preset threshold value, the processor 101 may stop generation of the microwave in the oscillator 210. That is, due to exhaustion of the aerosol generating materials in the like included in the tobacco rod 11, the aerosol generating article 10 that has been reused may have a permittivity significantly less than a permittivity of the aerosol generating article 10 that has not been used. Accordingly, the reflected microwave W2 of the aerosol generating article 10 that has been reused may be greater than the reflected microwave W2 of the aerosol generating article 10 that has not been used. In this case, the preset threshold value may be calculated in an experiment-statistic manner and stored in advance in the memory 106.

Any embodiments of the present disclosure or other embodiments described above are not mutually exclusive or distinct from each other. Any embodiment or other embodiments described in this disclosure may be combined with one another, both in terms of configurations and functions.

For example, configuration A from a specific embodiment and/or drawing can be combined with configuration B from another embodiment and/or drawing. This means that even if a combination of components is not explicitly described, such combinations are still possible unless specifically stated otherwise.

The detailed description above should not be interpreted as limiting in any respect, but rather as illustrative. The scope of the present invention should be defined by a reasonable interpretation of the appended claims, and all modifications that fall within the equivalent scope of the present invention are included in its scope.

An aerosol generating device of the disclosure may autonomously identify an aerosol generating article that has been inserted by using a reflected microwave reflected from a resonator to an oscillator, without addition of another insertion sensor.

Effects according to the embodiments are not limited to the aforementioned effects, and effects not mentioned above may be clearly understood by one of ordinary skill in the art from the present specification and the accompanying drawings.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An aerosol generating device comprising:
an oscillator configured to generate a microwave;
a resonator comprising an accommodation space accommodating an aerosol generating article, the resonator configured to heat the aerosol generating article by resonating the microwave;
a power monitoring unit configured to measure a reflected microwave reflected from the resonator and input to the oscillator; and
a processor configured to determine a type of the aerosol generating article based on the reflected microwave measured by the power monitoring unit.

2. The aerosol generating device of claim 1, further comprising
a memory storing relationships of a plurality of the aerosol generating articles and power profiles in a form of a look-up table.

3. The aerosol generating device of claim 2, wherein
the processor is further configured to adjust intensity of microwave power output from the oscillator according to a power profile corresponding to the aerosol generating article of the determined type, according to the look-up table.

4. The aerosol generating device of claim 1, further comprising
an insertion sensor configured to detect whether the aerosol generating article has been inserted into the accommodation space.

5. The aerosol generating device of claim 1, wherein
the processor is further configured to output an incident microwave from the oscillator when insertion of the aerosol generating article is sensed by the insertion sensor.

6. The aerosol generating device of claim 4, wherein
the insertion sensor comprises at least one of a film sensor, a pressure sensor, an optical sensor, a resistive sensor, a capacity sensor, an inductive sensor, and an infrared ray sensor.

7. The aerosol generating device of claim 1, wherein
the aerosol generating article comprises a tobacco rod and a filter rod, and the tobacco rod comprises an aerosol generating material and a dielectric material such as a flavoring agent.

8. The aerosol generating device of claim 7, wherein
the reflected microwave varies according to a permittivity of the dielectric material.

9. The aerosol generating device of claim 1, wherein,
when a value of the reflected microwave is equal to or greater than a preset threshold value, the processor is further configured to stop generation of the microwave in the oscillator.

10. The aerosol generating device of claim 9, further comprising
an output unit configured to deliver information regarding a state of the aerosol generating device to user by using any one of a visual sense, an auditory sense, and a tactile sense,
wherein the processor is further configured to notify the user, through the output unit, of the determined type of the aerosol generating article and/or whether the generation of the microwave has been stopped.

11. The aerosol generating device of claim 1, wherein
the resonator comprises a first inner conductor having a hollow cylinder shape surrounding an area of the aerosol generating article and a second inner conductor having a hollow cylinder shape surrounding another area of the aerosol generating article, and
the microwave is resonated by the first inner conductor and the second inner conductor.

12. The aerosol generating device of claim 1, wherein
the resonator
comprises a first plate surrounding an area of the aerosol generating article and a second plate separated from the first plate along a circumferential direction of the aerosol generating article and surrounding another area of the aerosol generating article, and
the microwave is resonated by the first plate and the second plate.

13. An operation method of an aerosol generating device comprising an oscillator configured to generate a microwave and a resonator comprising an accommodation space accommodating an aerosol generating article, the resonator configured to heat the aerosol generating article by resonating the microwave, the operation method comprising:
identifying whether the aerosol generating article has been inserted into the accommodation space;
generating an incident microwave output from the oscillator and input to the resonator when insertion of the aerosol generating article is identified;
measuring a reflected microwave reflected from the resonator and input to the oscillator; and
determining a type of the aerosol generating article based on the measured reflected microwave.

14. The operation method of claim 13, further comprising
adjusting intensity of microwave power output from the oscillator according to a power profile corresponding to the aerosol generating article of the determined type, based on a look-up table comprising a plurality of power profiles corresponding to a plurality of aerosol generating articles.

15. The operation method of claim 14, wherein
the adjusting of the intensity of the microwave power comprises, when the reflected microwave is equal to or greater than a preset threshold value, stopping the generation of the microwave in the oscillator.
